(19) United States
(12) Patent Application Publication
(10) Pub. No.: US 2014/0119283 A1
(43) Pub. Date: May 1, 2014

(54) METHOD FOR DETERMINING TRANSMISSION POWER

(71) Applicant: LG ELECTRONICS INC., Seoul (KR)

(72) Inventors: Dae Sung HWANG, Seoul (KR); Il Min KIM, Seoul (KR)

(73) Assignee: LG ELECTRONICS INC., Seoul (KR)

(21) Appl. No.: 14/065,084

(22) Filed: Oct. 28, 2013

Related U.S. Application Data
(60) Provisional application No. 61/719,524, filed on Oct. 29, 2012.

(51) Int. Cl. H04W 52/18

(52) U.S. Cl. CPC H04W 52/18
USPC 370/328

(57) ABSTRACT

There is a provided a method for deciding transmission power in order to transmit at least one of secret data and non-secret data. The method may comprise: determining whether data to be transmitted by a transmitting device is sensitive to a delay; determining whether both the secret data and the non-secret data are required to be simultaneously transmitted when the data to be transmitted is sensitive to the delay; and applying different weights to the secret data and the non-secret data and deciding transmission power to maximize a total channel capacity according to the application, when it is determined that both the secret data and the non-secret data are required to be transmitted.

### CROSS-REFERENCE TO RELATED APPLICATIONS

This application claims the benefit of priority of U.S. Provisional applications No. 61/719,524 filed on Oct. 29, 2012, all of which is incorporated by reference in their entirety herein.

### TECHNICAL FIELD

The present invention relates to a method for determining transmission power.

### BACKGROUND ART

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors). A terminal (user equipment, UE) 10 may be fixed or movable and may be called other terms such as a mobile station (MS), a mobile terminal (MT), a user terminal (UT), a subscriber station (SS), a wireless device, a personal digital assistant (PDA), a wireless modem, a handheld device, and the like. The base station 20 generally represents a fixed station that communicates with the terminal 10, and may be called different terms such as an evolved-NodeB (eNB), a base transceiver system (BTS), an access point, and the like.

The terminal generally belongs to one cell and the cell to which the terminal belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the terminal.

Hereinafter, a downlink means communication from the base station 20 to the terminal 10 and an uplink means communication from the terminal 10 to the base station 20. In the downlink, a transmitter may be a part of the base station 20 and a receiver may be a part of the terminal 10. In the uplink, the transmitter may be a part of the terminal 10 and the receiver may be a part of the base station 20.

Meanwhile, the wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmit antennas and a plurality of receive antennas. The MISO system uses a plurality of transmit antennas and one receive antenna. The SISO system uses one transmit antenna and one receive antenna. The SIMO system uses one transmit antenna and one receive antenna. Hereinafter, the transmit antenna means a physical or logical antenna used to transmit one signal or stream and the receive antenna means a physical or logical antenna used to receive one signal or stream.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Meanwhile, transmission power is a key matter to decide a cell coverage. However, when the transmission power is increased, since the transmission power is overheard by a third person, the transmission power may not be thoughtlessly increased.

### DISCLOSURE OF THE INVENTION

Therefore, one disclosure of the specification is to provide techniques for optimizing transmission power.

To achieve these and other advantages and in accordance with the purpose of the present invention, as embodied and broadly described herein, there is provided a method.

In one aspect, there is a provided method for deciding transmission power in order to transmit at least one of secret data or non-secret data. The method may comprise: determining whether data to be transmitted by a transmitting device is sensitive to a delay; determining whether both the secret data and the non-secret data are required to be simultaneously transmitted when the data to be transmitted is sensitive to the delay; and applying different weights to the secret data and the non-secret data and deciding transmission power to maximize a total channel capacity according to the application, when it is determined that both the secret data and the non-secret data are required to be transmitted.

The method may further comprise: determining whether both the secret data and the non-secret data are required to be simultaneously transmitted when it is determined that the data to be transmitted is not sensitive to the delay; deciding optimal transmission power by minimizing an outage probability when target secret transmission rate Rₛ is given in the case where it is determined that only the secret data is required to be transmitted; and deciding the target secret transmission rate Rₛ in order to maximize a system throughput.

The method may further comprise: calculating the outage probability by considering both the non-secret data and the secret data when it is determined that the data to be transmitted is not sensitive to the delay and it is determined that both the secret data and the non-secret data are required to be transmitted; and deciding transmission power to minimize the outage probability.

The method may further comprise: calculating the outage probability for each of the non-secret data and the secret data when it is determined that the data to be transmitted is not sensitive to the delay and it is determined that both the secret data and the non-secret data are required to be transmitted; and deciding transmission power to minimize the outage probability for the secret data while ensuring a maximum value of the outage probability for the non-secret data.

The method may further comprise: determining whether both the secret data and the non-secret data are required to be transmitted when it is determined that only some of the data to be transmitted is sensitive to the delay; and deciding transmission power to maximize an ergodic channel capacity of the secret data while meeting a minimum outage probability of the secret data when it is determined that only some of the data to be transmitted is sensitive to the delay and it is determined that only the secret data is required to be transmitted.

The method may further comprise: applying different weights to the non-secret data and the secret data in order to maximize a total channel capacity for the secret data and the non-secret data when it is determined that only some of the data to be transmitted is sensitive to the delay, but both the secret data and the non-secret data are required to be transmitted; and deciding the transmission power by considering both the outage probability for the non-secret data and the outage probability of the secret data.

The method may further comprise: deciding transmission power to maximize a channel capacity for the secret data, but constrain the maximum value of the outage probability for the non-secret data in order to maximize the channel capacity for the secret data when it is determined that only some of the data to be transmitted is sensitive to the delay, but both the secret data and the non-secret data are required to be transmitted.

The method may further comprise: deciding transmission power to maximize a channel capacity for the non-secret data, but constrain the maximum value of the outage probability for the secret data in order to maximize the channel capacity for the non-secret data when it is determined that only some of the data to be transmitted is sensitive to the delay, but both the secret data and the non-secret data are required to be transmitted.

When the transmission power of the wireless communication system is optimized by the methods proposed in the present invention, the following effects are obtained. When transmitted data is not sensitive to a transmission delay, an ergodic channel capacity can be maximized by optimizing the transmission power. In particular, when both non-secret data and secret data are transmitted, different weights are given to two different types to optimize the transmission power, thereby adjusting a non-secret channel capacity value and a secret channel capacity value.

When the transmitted data is sensitive to the transmission delay, an outage probability can be minimized by optimizing the transmission power. When the outage probability is minimized, an outage probability considering both the non-secret data and the secret data may be minimized, only an outage probability for the non-secret data may be minimized, or only an outage probability for the secret data may be minimized. Further, instead of an optimal power distribution that minimizes the outage probability, target transmission rate at a receiver may be optimized so as to maximize a system throughput.

Last, when only some of the transmitted data is sensitive to the transmission delay, the ergodic channel capacity can be maximized while preventing the outage probability from being increased to a predetermined reference value or more by optimizing the transmission power. The optimization of the transmission power can be performed in all of a case in which only the non-secret data is transmitted, a case in which only the secret data is transmitted, and a case in which both the secret data and the non-secret data are transmitted.

### BRIEF DESCRIPTION OF THE DRAWINGS

FIG. 1 is view of an evolved mobile communication network;

FIG. 2 shows a downlink radio frame structure in 3rd generation partnership project (3GPP) long term evolution (LTE).

FIG. 3 shows the structure of an uplink subframe in 3rd generation partnership project (3GPP) long term evolution (LTE).

FIG. 4 shows a concept of a communication system by an information theory.

FIG. 5 shows an example in which the concept by the information theory shown in FIG. 4 is applied to a mobile system.

FIG. 6 shows an example, in which data which is not sensitive to transmission delay is transmitted according to a first embodiment.

FIG. 7 shows an example, in which data which is sensitive to transmission delay is transmitted according to a second embodiment.

FIG. 8 shows an example, in which data which is sensitive and data which is not sensitive to transmission delay is transmitted simultaneously according to a third embodiment.

FIG. 9 shows an example of a concept of device to device (D2D) to which the embodiments can be applied.

FIG. 10 is a flowchart shown by synthesizing the embodiments.

FIG. 11 is a block diagram showing a wireless communication system to implement an embodiment of the present invention.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of a drain device and a refrigerator having the same according to an embodiment, with reference to the accompanying drawings.

The present invention will be described on the basis of a universal mobile telecommunication system (UMTS) and an evolved packet core (EPC). However, the present invention is not limited to such communication systems, and it may be also applicable to all kinds of communication systems and methods to which the technical spirit of the present invention is applied.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

The terms used herein including an ordinal number such as first, second, etc. can be used to describe various elements, but the elements should not be limited by those terms. The terms are used merely to distinguish an element from the other element. For example, a first element may be named to a second element, and similarly, a second element may be named to a first element.

In case where an element is “connected” or “linked” to the other element, it may be directly connected or linked to the other element, but another element may be existed therebetween. On the contrary, in case where an element is “directly connected” or “directly linked” to another element, it should be understood that any other element is not existed therebetween.

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings. The spirit of the invention should be construed as being extended even to all changes, equivalents, and substitutes other than the accompanying drawings.

There is an exemplary terminal in accompanying drawings, however the terminal may be referred to as terms such as a user equipment (UE), a mobile equipment (ME), a mobile station (MS), a user terminal (UT), a subscriber station (SS), a wireless device (WD), a handheld device (HD), an access terminal (AT), and etc. And, the terminal may be implemented as a portable device such as a notebook, a mobile phone, a PDA, a smart phone, a multimedia device, etc, or as an unportable device such as a PC or a vehicle-mounted device.

The 3GPP LTE uses an orthogonal frequency division multiple access (OFDMI) in a downlink and a single carrier-frequency division multiple access (SC-FDMI) in an uplink. The OFDM needs to know in order to understand the OFDMA. The OFDM may be used since an inter-symbol interference effect can be reduced due to low complexity. The OFDM converts data to be input in serial into N parallel data and transmits it by carrying N orthogonal sub-carriers. The sub-carriers maintains orthogonally in a frequency dimension. Meanwhile, the OFDMA means a multiple access method to realize multiple accesses by providing a part of the available sub-carrier to each user independently, in a system using the OFDM in a modulation scheme.

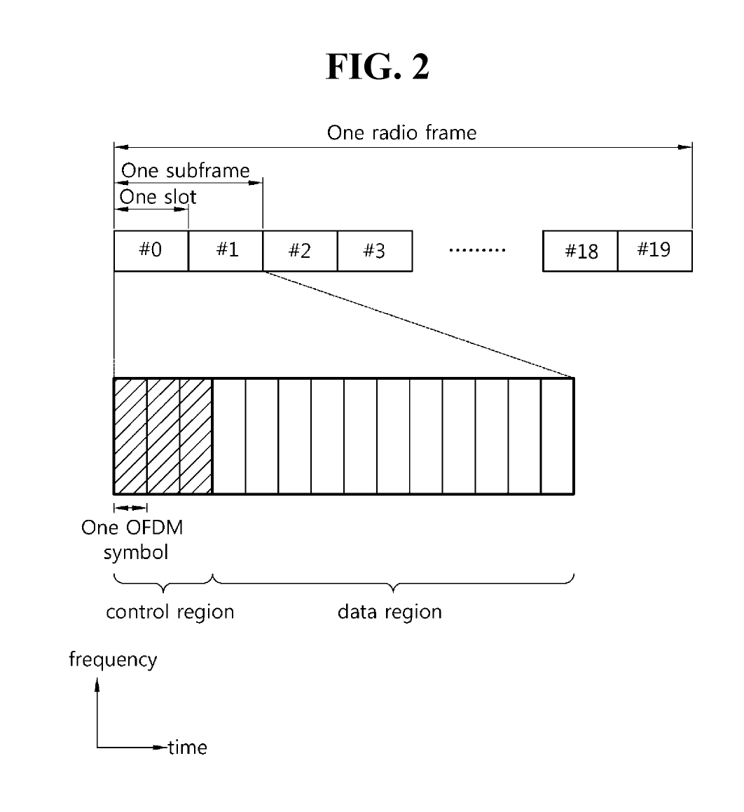

FIG. 2 shows a downlink radio frame structure in 3rd generation partnership project (3GPP) long term evolution (LTE). The section 6 of 3GPP TS 36.211 V8.7.0 (2009-05) “Evolved Universal Terrestrial Radio Access (E-UTRI); Physical Channels and Modulation (Release 8)” may be incorporated herein.

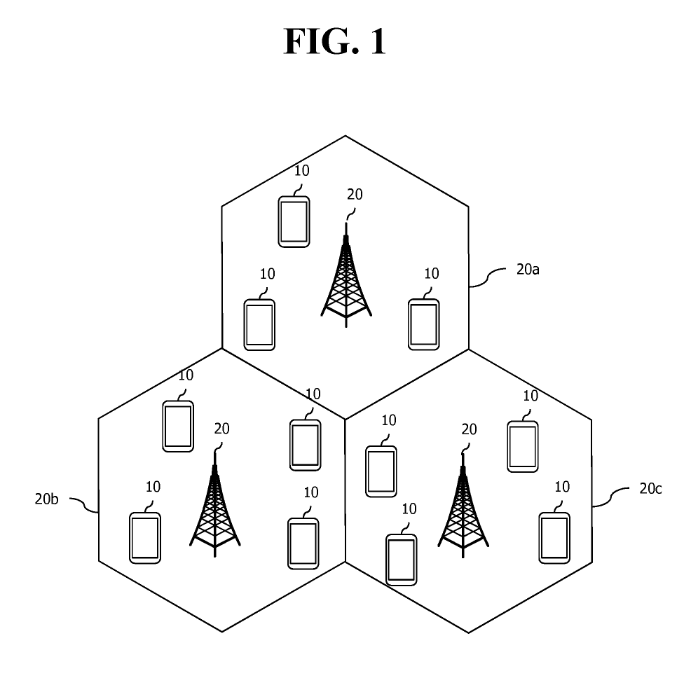

As shown in FIG. 1, a radio frame includes 10 subframes indexed with 0 to 9. One subframe includes 2 consecutive slots. A time required for transmitting one subframe is defined as a transmission time interval (TTI). For example, one subframe may have a length of 1 millisecond (ms), and one slot may have a length of 0.5 ms.

One slot may include a plurality of orthogonal frequency division multiplexing (OFDM) symbols in a time domain. Since the 3GPP LTE uses orthogonal frequency division multiple access (OFDMI) in a downlink (DL), the OFDM symbol is only for expressing one symbol period in the time domain, and there is no limitation in a multiple access scheme or terminologies. For example, the OFDM symbol may also be referred to as another terminology such as a single carrier frequency division multiple access (SC-FDMI) symbol, a symbol period, etc.

Although it is described that one slot includes 7 OFDM symbols for example, the number of OFDM symbols included in one slot may vary depending on a length of a cyclic prefix (CP). According to 3GPP TS 36.211, V8.7.0, in case of a normal CP, one slot includes 7 OFDM symbols, and in case of an extended CP, one slot includes 6 OFDM symbols.

A resource block (RII) is a resource allocation unit, and includes a plurality of subcarriers in one slot. For example, if one slot includes 7 OFDM symbols in a time domain and the RB includes 12 subcarriers in a frequency domain, one RB can include 7×12 resource elements (REs).

A DL subframe is divided into a control region and a data region in the time domain. The control region includes up to first three OFDM symbols of a 1st slot in the subframe. However, the number of OFDM symbols included in the control region may vary. A physical downlink control channel (PDCCH) and other control channels are allocated to the control region, and a physical downlink shared channel (PDSCH) is allocated to the data region.

As disclosed in 3GPP TS 36.211 V8.7.0, the 3GPP LTE classifies a physical channel into a data channel and a control channel. Examples of the data channel include a physical downlink shared channel (PDSCH) and a physical uplink shared channel (PUSCH). Examples of the control channel include a physical downlink control channel (PDCCH), a physical control format indicator channel (PCFICH), a physical hybrid-ARQ indicator channel (PHICH), and a physical uplink control channel (PUCCH).

The PCFICH transmitted in a 1st OFDM symbol of the subframe carries a control format indicator (CFI) regarding the number of OFDM symbols (i.e., a size of the control region) used for transmission of control channels in the subframe. The UE first receives the CFI on the PCFICH, and thereafter monitors the PDCCH.

Unlike the PDCCH, the PCFICH is transmitted by using a fixed PCFICH resource of the subframe, without having to perform blind decoding.

The PHICH carries a positive-acknowledgement (ACK)/negative-acknowledgement (NACK) signal for an uplink hybrid automatic repeat request (HARQ). The ACK/NACK signal for UL data on a PUSCH transmitted by the UE is transmitted on the PHICH.

A physical broadcast channel (PBCH) is transmitted in first four OFDM symbols in a 2nd slot of a 1st subframe of a radio frame. The PBCH carries system information necessary for communication between the UE and the BS. The system information transmitted through the PBCH is referred to as a master information block (MIII). In comparison thereto, system information transmitted on the PDCCH indicated by the PDCCH is referred to as a system information block (SIII).

Control information transmitted through the PDCCH is referred to as downlink control information (DCI). The DCI may include resource allocation of the PDSCH (this is referred to as a DL grant), resource allocation of a PUSCH (this is referred to as a UL grant), a set of transmit power control commands for individual UEs in any UE group, and/or activation of a voice over Internet protocol (VoIP).

The 3GPP LTE uses blind decoding for PDCCH detection. The blind decoding is a scheme in which a desired identifier is de-masked from a cyclic redundancy check (CRC) of a received PDCCH (referred to as a candidate PDCCH) to determine whether the PDCCH is its own control channel by performing CRC error checking.

The BS determines a PDCCH format according to DCI to be transmitted to the UE, attaches a CRC to the DCI, and masks a unique identifier (referred to as a radio network temporary identifier (RNTI)) to the CRC according to an owner or usage of the PDCCH.

A control region in a subframe includes a plurality of control channel elements (CCEs). The CCE is a logical allocation unit used to provide the PDCCH with a coding rate depending on a radio channel state, and corresponds to a plurality of resource element groups (REGs). The REG includes a plurality of resource elements. According to an association relation of the number of CCEs and the coding rate provided by the CCEs, a PDCCH format and the number of bits of the available PDCCH are determined.

One REG includes 4 REs. One CCE includes 9 REGs. The number of CCEs used to configure one PDCCH may be selected from a set {1, 2, 4, 8}. Each element of the set {1, 2, 4, 8} is referred to as a CCE aggregation level.

The BS determines the number of CCEs used in transmission of the PDCCH according to a channel state. For example, a UE having a good DL channel state can use one CCE in PDCCH transmission. A UE having a poor DL channel state can use 8 CCEs in PDCCH transmission.

A control channel consisting of one or more CCEs performs interleaving in an REG unit, and is mapped to a physical resource after performing cyclic shift based on a cell identifier (ID).

Now, maintaining of a UL time alignment in 3GPP LTE will be described.

To decrease an interference caused by UL transmission between UEs, it is important for a BS to maintain a UL time alignment of the UEs. The UE may be located in any area in a cell. A UL signal transmitted by the UE may arrive to the BS at a different time according to the location of the UE. A signal arrival time of a UE located in a cell edge is longer than a signal arrival time of a UE located in a cell center. On the contrary, the signal arrival time of the UE located in the cell center is shorter than the signal arrival time of the UE located in the cell edge.

To decrease the interference between the UEs, the BS needs to perform scheduling so that UL signals transmitted by the UEs in the cell can be received every time within a boundary. The BS has to properly adjust transmission timing of each UE according to a situation of each UE. Such an adjustment is called a time alignment maintenance.

A random access procedure is one of methods for managing the time alignment. The UE transmits a random access preamble to the BS. The BS calculates a time alignment value for advancing or delaying transmission timing of the UE on the basis of the received random access preamble. In addition, the BS transmits a random access response including the calculated time alignment value to the UE. The UE updates the transmission timing by using the time alignment value.

In another method, the BS receives a sounding reference signal from the UE periodically or randomly, calculates the time alignment value of the UE by using the sounding reference signal, and reports a MAC control element (CE) to the UE.

The time alignment value is information sent by the BS to the UE to maintain uplink time alignment. A timing alignment command indicates this information.

Since the UE has mobility in general, the transmission timing of the UE varies depending on a moving speed, a location, or the like of the UE. Therefore, the time alignment value received by the UE is preferably valid during a specific time period. For this, a time alignment timer is used.

When the time alignment is updated after receiving the time alignment value from the BS, the UE starts or restarts the time alignment timer. The UE can perform UL transmission only when the time alignment timer is running. A value of the time alignment timer may be reported by the BS to the UE by using system information or an RRC message such as a radio bearer reconfiguration message.

When the time alignment timer expires or when the time alignment timer does not run, the UE does not transmit any uplink signal except for the random access preamble under the assumption that time alignment is not achieved between the BS and the UE.

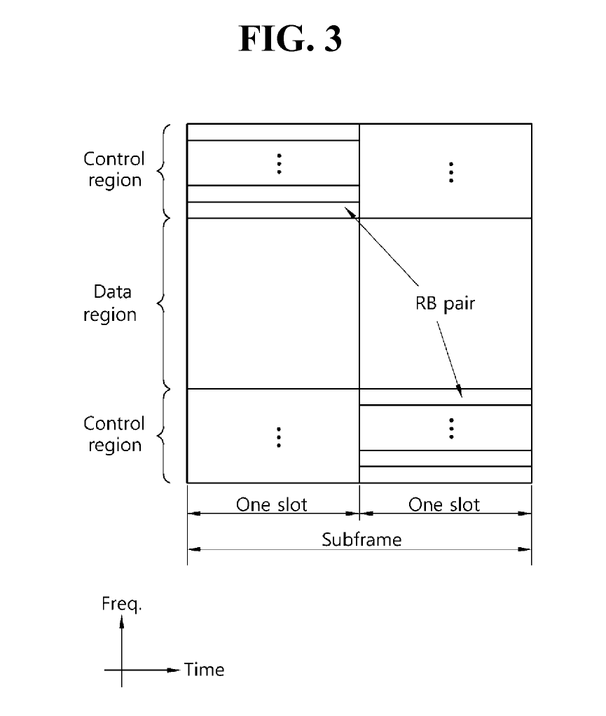

FIG. 3 shows the structure of an uplink subframe in 3rd generation partnership project (3GPP) long term evolution (LTE).

Referring FIG. 3, an uplink subframe may be divided into a control region and a data region in the frequency domain. A physical uplink control channel (PUCCH) for transmitting uplink control information is allocated to the control region. A physical uplink shared channel (PUCCH) for transmitting data is allocated to the data region. If indicated by a higher layer, the user equipment may support simultaneous transmission of the PUCCH and the PUSCH.

The PUSCH is mapped to a uplink shared channel (UL-SCH), a transport channel. Uplink data transmitted on the PUSCH may be a transport block, a data block for the UL-SCH transmitted during the TTI. The transport block may be user information. Or, the uplink data may be multiplexed data. The multiplexed data may be data obtained by multiplexing the transport block for the UL-SCH and control information. For example, control information multiplexed to data may include a channel quality indicator (CQI), a precoding matrix indicator (PMI), an HARQ, a rank indicator (RI), or the like. Or the uplink data may include only control information.

The following description is about a PUCCH.

The PUCCH for one UE is allocated in an RB pair. RBs belonging to the RB pair occupy different subcarriers in each of a 1st slot and a 2nd slot. A frequency occupied by the RBs belonging to the RB pair allocated to the PUCCH changes at a slot boundary. This is called that the RB pair allocated to the PUCCH is frequency-hopped at a slot boundary. Since the UE transmits UL control information over time through different subcarriers, a frequency diversity gain can be obtained. In the figure, m is a location index indicating a logical frequency-domain location of the RB pair allocated to the PUCCH in the subframe.

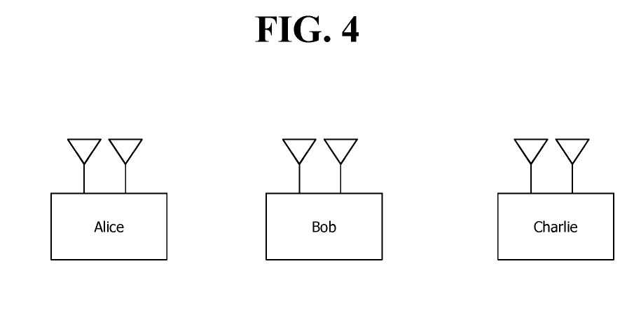

FIG. 4 shows a concept of a communication system by an information theory.

As illustrated in FIG. 4, in a wireless communication system including a wireless communication apparatus of Alice, a wireless communication apparatus of Bob, and a wireless communication apparatus of Charlie, a channel capacity induced by the information theory shows a maximum value of data transmission rate which is transmittable in the wireless communication system. For example, a received signal in Bob, r_{b} is given as below.

r_{b}=h_{b}x+η_{b} [Equation 1]

Herein, h_{b} represents a channel between Alice and Bob, x represents a transmit signal, and η_{b} represents additive white Gaussian noise in Bob. The channel capacity in the wireless communication system is given as below.

$${C}_{n} = {log}_{2} ( 1 + \frac{{\vert {h}_{b} \vert}^{2} p}{{σ}_{b}^{2}} ) \qquad [ Equation 2 ]$$

However, E[|x|²]=p represents transmission power and σ_{b}² represents a variance of η_{b} However, since data which is transmitted as above may be received by anyone else as well as Bob, the data is called “non-secret data” in this specification.

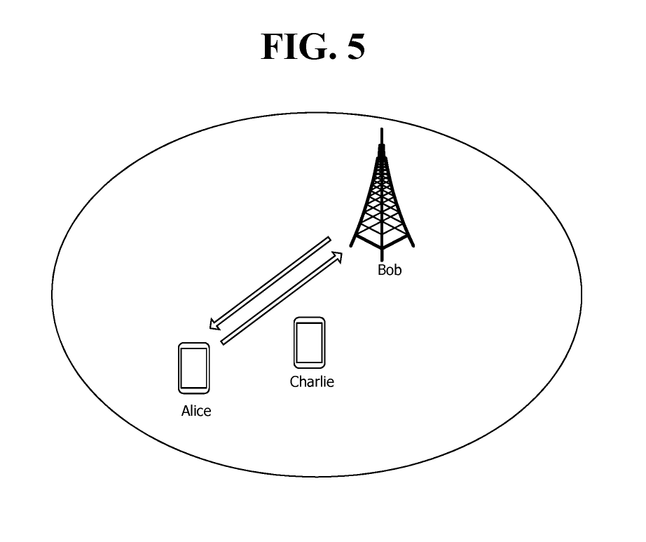

FIG. 5 shows an example in which the concept by the information theory shown in FIG. 4 is applied to a mobile system.

As seen with reference to FIG. 5, when Alice and Charlie are wireless terminals and Bob is the base station, data which Alice and Bob transmit and receive may be overheard by Charlie.

Therefore, in the wireless communication system, it is important to secretly transmit data so as to prevent data from being overheard (received and decoded) by an undesired receiver.

To this end, in an existing method which is primarily used up to now, data is encoded/decoded by using an encryption/decryption theory (cryptography). To this end, both a transmitter and a receiver should have a secret key and to this end, the system performs secret key management.

However, it may be difficult or very complicated that the wireless communication system performs the secret key management. Further, transmission of secret data by the encoding theory has a limit that the transmission cannot provide perfect secret.

In order to solve the problems, physical layer security has been studied a lot in recent years. A physical layer security method allows a signal transmitted by a transmitter to be normally received by a desired receiver, however, prevents the transmitted signal from being received by a wiretapper or decoded even though the transmitted signal is received by the wiretapper, by using the information theory and a signal processing theory. A lot of methods of secretly transmitting data through a wireless channel have been proposed and researched, based on the new approach.

In the physical layer security system, Alice, Bob, and Charlie are regarded as a transmitter, a legal receiver, and a wiretapper, respectively, and a received signal in Bob is given by [Equation 1] above and a received signal in Charlie, rₑ is given by [Equation 3] below.

rₑ=hₑx+ηₑ [Equation 3]

In the system, a maximum value of a data transmission rate which may be secretly transmitted without being overheard by using the physical layer secret method is referred to as a secrecy channel capacity and is given by [Equation 4] below.

$${C}_{s} = {( {log}_{2} ( 1 + \frac{{\vert {h}_{b} \vert}^{2} p}{{σ}_{b}^{2}} ) - {log}_{2} ( 1 + \frac{{\vert {h}_{c} \vert}^{2} p}{{σ}_{c}^{2}} ) )}^{+} \qquad [ Equation 4 ]$$

Herein, (x)⁺ is defined as follows.

(x)⁺=x if x>0 and (x)⁺=0 if x≦0 [Equation 5]

As described above, since data transmitted by the physical layer scurity method is received by only Bob and not received by Charlie, the data is called “secret data” in this specification.

Meanwhile, optimizing the transmission power in the wireless communication system is very important due to minimization of consumption of system power, maximization of battery use hours, minimization of interference to other users, assurance of quality of transmitted data (quality of service: QoS), and the like. The power optimization has been researched a lot up to now and the transmission power should be optimized differently depending on a type of data. The optimization of the transmission power is performed with respect to three cases below in this specification.

i) Without transmission delay constraint

ii) With transmission delay constraint

iii) With partial transmission delay constraint

In an existing research, an optimal power control method had been developed by regarding a case in which only the non-secret data is transmitted with respect to respective cases i), ii) and iii). Further, the optimal power control method had been developed even in a case in which only the secret data is transmitted, with respect to cases i) and ii). However, the optimal power control method has not been developed up to now in the case in which the secret data is transmitted, with respect to case iii). Further, the existing research, the optimal power control methods had been researched on the assumption of the case in which only the non-secret data is transmitted or only the secret data is transmitted.

However, both the non-secret data and the secret data may be transmitted as described above. When both data are transmitted, the wireless channel may be more efficiently used. Therefore, optimizing of power transmission in such a case is also important. However, the optimal power control method in such a case has not been developed up to now.

Therefore, an object of this specification is to present the optimal power control methods in the case in which the secret data is transmitted with respect to case iii) and a case in which both the non-secret data and the secret data are transmitted with respect to cases i), ii), and iii).

That is, this specification presents a new power transmission optimizing method in cases below.

ii) a case in which both non-secret data and secret data are transmitted, without transmission delay constraint

ii) a case in which both non-secret data and secret data are transmitted, with transmission delay constraint

iii) a case in which only secret data is transmitted/a case in which both non-secret data and secret data are transmitted, with partial transmission delay constraint

Hereinafter, transmission power p is expressed by p(|h_{b}|) in the case of a function of a channel gain |h_{b}| up to Bob, and the transmission power p is expressed by p(h) in the case of functions of channel gains |h_{b}| and |hₑ| up to Bob and Charlie. However, herein, h=(|h_{b}|, |hₑ|). Further, it is assumed that mean power consumption is limited as below.

[symbol]

[p(|h_{b}|)]≦ P̅ₐᵥ [Equation 6]

Or

[symbol]

[p(h)]≦ P̅ₐᵥ [Equation 7]

Herein, P̅ₐᵥ represents an upper limit value of the mean power consumption.

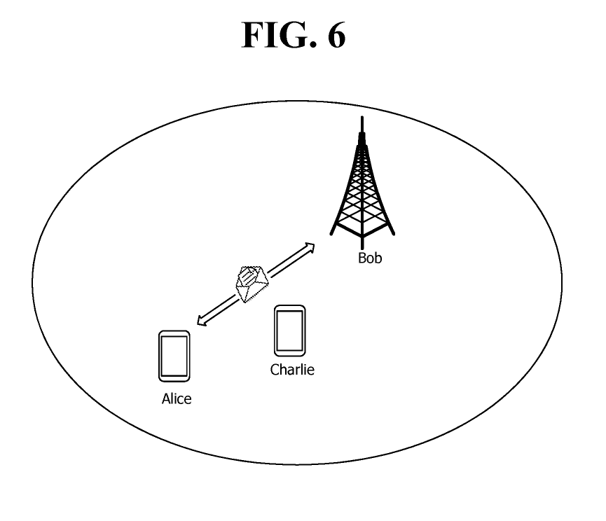

FIG. 6 shows an example in which data which is not sensitive to a transmission delay is transmitted according to a first embodiment.

As seen with reference to FIG. 6, when a situation in which data such as a file or an e-mail which is not very sensitive to the transmission delay is transferred between Alice and Bob is considered, a block length or a codeword length of transmitted data may be sufficiently large and it may be assumed that a channel suffers a change in one block. Under this situation, an index of performance is a well-known ergodic channel capacity.

Under this situation, the method for optimizing the transmission power will be described below, in each of the case in which non-secret data is transmitted, the case in which only the secret data is transmitted, or the case in which the non-secret data and the secret data are transmitted.

First, the method for optimizing the transmission power in the case in which only the non-secret data is transmitted will be described below.

In the case in which only the non-secret data is transmitted, a question of acquiring optimal power is given by Equation 8 below.

$${C}_{n} = {max}_{{p}_{n} ( \vert {h}_{b} \vert )} 𝔼 [ {log}_{2} ( 1 + \frac{{\vert {h}_{b} \vert}^{2} {p}_{n} ( \vert {h}_{b} \vert )}{{σ}_{b}^{2}} ) ] \\ subject to \text{:} 𝔼 [ {p}_{n} ( \vert {h}_{b} \vert ) ] \leq {\overline{P}}_{av} . \qquad [ Equation 8 ]$$

A solution for the optimization question is very well-known classical “water-filling” and the optimal power is given by Equation 9 below.

$${p}_{n}^{*} ( \vert {h}_{b} \vert ) = {p}_{n}^{wf} ( \vert {h}_{b} \vert ) := {( \frac{1}{λ} - \frac{{σ}_{b}^{2}}{{\vert {h}_{b} \vert}^{2}} )}^{+} , \\ for all \vert {h}_{b} \vert \qquad [ Equation 9 ]$$

However, λ is acquired to meet a mean power condition as shown in Equation 10 below.

[symbol]

[p*(|h_{b}|)]= P̅ₐᵥ [Equation 10]

Second, the method for optimizing the transmission power in the case in which only the secret data is transmitted will be described below.

In the case in which only the secret data is transmitted, a question of acquiring optimal power is given by Equation 11 below.

$${C}_{s} = {max}_{{p}_{s} ( h )} 𝔼 [ {( {log}_{2} ( 1 + \frac{{\vert {h}_{b} \vert}^{2} {p}_{s} ( h )}{{σ}_{b}^{2}} ) - {log}_{2} ( 1 + \frac{{\vert {h}_{e} \vert}^{2} {p}_{s} ( h )}{{σ}_{e}^{2}} ) )}^{+} ] \\ subject to \text{:} 𝔼 [ {p}_{s} ( h ) ] \leq {\overline{P}}_{av} . \qquad [ Equation 11 ]$$

A solution to the optimization question is given as shown in Equation 12 below.

$$\begin{matrix}{p}_{s}^{*} ( h ) = {p}_{s}^{s - wf} ( h ) \\ := \{ \begin{matrix}\frac{1}{2} {( \begin{matrix}- ( \frac{{σ}_{b}^{2}}{{\vert {h}_{b} \vert}^{2}} + \frac{{σ}_{e}^{2}}{{\vert {h}_{e} \vert}^{2}} ) + \\ \sqrt{\begin{matrix}{( \frac{{σ}_{e}^{2}}{{\vert {h}_{e} \vert}^{2}} - \frac{{σ}_{b}^{2}}{{\vert {h}_{b} \vert}^{2}} )}^{2} + \\ \frac{4}{λ} ( \frac{{σ}_{e}^{2}}{{\vert {h}_{e} \vert}^{2}} - \frac{{σ}_{b}^{2}}{{\vert {h}_{b} \vert}^{2}} )\end{matrix}}\end{matrix} )}^{+} , & \begin{matrix}if \frac{{\vert {h}_{b} \vert}^{2}}{{σ}_{b}^{2}} > \\ \frac{{\vert {h}_{e} \vert}^{2}}{{σ}_{e}^{2}} > 0\end{matrix} \\ 0 , & \begin{matrix}if \frac{{\vert {h}_{e} \vert}^{2}}{{σ}_{e}^{2}} \geq \\ \frac{{\vert {h}_{b} \vert}^{2}}{{σ}_{b}^{2}} > 0\end{matrix}\end{matrix}\end{matrix} \qquad [ Equation 12 ]$$

However, λ>0 is acquired to meet the mean power condition [symbol] [p*(h)]= P̅ₐᵥ. Such the optimal power control method is known as “secure water-filling (s-wf)”.

Third, the method for optimizing the transmission power in the case in which both the non-secret data and the secret data are transmitted will be described below.

In the existing research, optimal power is derived by assuming the case in which only the non-secret data is transmitted or the case in which only the secret data is transmitted. However, actually, both the non-secret data and the secret data may be transmitted. When the case is expressed by an equation, a channel capacity of the secret data may be given by Equation 13 below.

$${C}_{s} ( {p}_{ns} ( h ) ) := 𝔼 [ {( {log}_{2} ( 1 + \frac{{\vert {h}_{b} \vert}^{2} {p}_{ns} ( h )}{{σ}_{b}^{2}} ) - {log}_{2} ( 1 + \frac{{\vert {h}_{e} \vert}^{2} {p}_{ns} ( h )}{{σ}_{e}^{2}} ) )}^{+} ] \qquad [ Equation 13 ]$$

A channel capacity of the non-secret data which may be transmitted simultaneously as above is given by Equation 14 below.

$${C}_{n} ( {p}_{ns} ( h ) ) := E [ min \{ {log}_{2} ( 1 + \frac{{\vert {h}_{b} \vert}^{2} {p}_{ns} ( h )}{{σ}_{b}^{2}} ) , {log}_{2} ( 1 + \frac{{\vert {h}_{e} \vert}^{2} {p}_{ns} ( h )}{{σ}_{e}^{2}} ) \} ] \qquad [ Equation 14 ]$$

Therefore, a channel capacity of the sum of the secret data and the non-secret data is given as below.

Cₙₛ(pₙₛ(h))=Cₛ(pₙₛ(h))+Cₙ(pₙₛ(h)) [Equation 15]

Now, a question for maximizing the total channel capacity may be solved in order to optimize the transmission power. However, in this specification, a most generalized optimization question is proposed and solved. That is, a power optimization question is proposed, in such a manner of giving different weights to the non-secret data and the secret data, not optimizing power in such a manner of maximizing the sum of the non-secret data and the secret data. This is expressed by Equation 16 below.

$${max}_{{p}_{ns} ( h )} ( {aC}_{s} ( {p}_{ns} ( h ) ) + ( 1 - α ) {C}_{n} ( {p}_{ns} ( h ) ) ) \\ subject to \text{:} E [ {p}_{ns} ( h ) ] \leq {\overline{P}}_{av} \qquad [ Equation 16 ]$$

However, 0≦α≦1. The question for acquiring the optimal power may be appreciated as a most generalized format of an existing given question. For example, when α=1, a channel capacity for only the secret data, Cₛ(pₙₛ(h)) is optimized. When α=0, a channel capacity for only the non-secret data, Cₛ(pₙₛ(h)) is optimized. When α=0.5, a channel capacity for the sum of the secret data and the non-secret data, Cₙ(pₙₛ(h))+Cₛ(pₙₛ(h)) is optimized. In the case of a general α value, a question for giving different weights to the secret data and the non-secret data is solved. Herein, it is important to send only the non-secret data even when α is 0. α=0 means that the transmission power is optimized by considering only the non-secret data. The secret data is also actually transmitted with the channel capacity of Cₛ(pₙₛ(h)). Similarly, only the secret data is not sent even when α=1. α=1 means that the transmission power is optimized by considering only the secret data. The non-secret data is also actually transmitted with the channel capacity of Cₙ(pₙₛ(h)). That is, when power optimized by a predetermined α value is expressed by pₙₛ*(h), actually transmitted data is given by Equation 17 below at all times.

Cₙₛ(pₙₛ*(h))=Cₛ(pₙₛ*(h))+Cₙ(pₙₛ(h)) [Equation 17]

A solution for the optimization question may be mathematically acquired, and the solution is given as follows.

$$[ Equation 18 ]$$

$$\begin{matrix}{p}_{ns}^{*} ( h ) = {p}_{ns}^{c - wf} ( h ) \\ = \{ \begin{matrix}\frac{1}{2} ( - ( \frac{{σ}_{b}^{2}}{{\vert {h}_{b} \vert}^{2}} + \frac{{σ}_{e}^{2}}{{\vert {h}_{c} \vert}^{2}} + \frac{α - 1}{λ} ) + \sqrt{{( \frac{{σ}_{b}^{2}}{{\vert {h}_{b} \vert}^{2}} + \frac{{σ}_{e}^{2}}{{\vert {h}_{e} \vert}^{2}} + \frac{α - 1}{λ} )}^{2} - 4 ( \frac{{σ}_{b}^{2} {σ}_{e}^{2}}{{\vert {h}_{b} \vert}^{2} {\vert {h}_{e} \vert}^{2}} + \frac{1}{λ} ( \frac{( 2 α - 1 ) {σ}_{b}^{2}}{{\vert {h}_{b} \vert}^{2}} - \frac{{ασ}_{e}^{2}}{{\vert {h}_{e} \vert}^{2}} ) )} ) , & if \frac{{\vert {h}_{b} \vert}^{2}}{{σ}_{b}^{3}} > \frac{{\vert {h}_{e} \vert}^{2}}{{σ}_{e}^{2}} > 0 \\ {( \frac{1 - α}{λ} - \frac{{σ}_{b}^{2}}{{\vert {h}_{b} \vert}^{2}} )}^{+} , & if \frac{{\vert {h}_{e} \vert}^{2}}{{σ}_{e}^{2}} \geq \frac{{\vert {h}_{b} \vert}^{2}}{{σ}_{b}^{2}} > 0\end{matrix}\end{matrix}$$

Herein, λ is acquired to meet the mean power condition [symbol] [p*(|h_{b})]= P̅ₐᵥ. In this specification, such an optimal power method 20 is called “combined water-filling (c-wf)”.

Hereinafter, in some special cases described above, it will be described how the generalized “combined water-filling” is given.

First, it will be described how the generalized “combined water-filling” is given when α=0. In this case, the channel capacity of only the non-secret data, Cₙ(Pₙₛ(h)) is optimized and in this case, a solution of the “combined water-filling” is given as below.

$$\begin{matrix}{p}_{ns}^{*} ( h ) = \{ \begin{matrix}{( \frac{1}{λ} - \frac{{σ}_{e}^{2}}{{\vert {h}_{e} \vert}^{2}} )}^{+} , & if \frac{{\vert {h}_{b} \vert}^{2}}{{σ}_{b}^{2}} > \frac{{\vert {h}_{e} \vert}^{2}}{{σ}_{e}^{2}} > 0 \\ {( \frac{1}{λ} - \frac{{σ}_{b}^{2}}{{\vert {h}_{b} \vert}^{2}} )}^{+} , & if \frac{{\vert {h}_{e} \vert}^{2}}{{σ}_{e}^{2}} \geq \frac{{\vert {h}_{b} \vert}^{2}}{{σ}_{b}^{2}} > 0\end{matrix} \\ = {( \frac{1}{λ} - max \{ \frac{{σ}_{b}^{2}}{{\vert {h}_{b} \vert}^{2}} , \frac{{σ}_{e}^{2}}{{\vert {h}_{e} \vert}^{2}} \} )}^{+} \\ \text{=:} {p}_{n}^{n - wf} ( h )\end{matrix} \qquad [ Equation 19 ]$$

However, λ is acquired to meet the mean power condition [symbol] [pₙ^{u-wf}(h)]= P̅ₐᵥ. Herein, a cautious point is that given pᵤ^{n-wf} is different from conventional water-filling pₙ^{wf}(h).

As a next special case, α=1 will be described. In this case, the solution for the “combined water-filling” is given as below.

$$\begin{matrix}{p}_{ns}^{*} ( h ) = \{ \begin{matrix}\frac{1}{2} ( - ( \frac{{σ}_{b}^{2}}{{\vert {h}_{b} \vert}^{2}} + \frac{{σ}_{e}^{2}}{{\vert {h}_{c} \vert}^{2}} ) + \sqrt{{( \frac{{σ}_{b}^{2}}{{\vert {h}_{b} \vert}^{2}} + \frac{{σ}_{e}^{2}}{{\vert {h}_{e} \vert}^{2}} )}^{2} - 4 ( \frac{{σ}_{b}^{2} {σ}_{e}^{2}}{{\vert {h}_{b} \vert}^{2} {\vert {h}_{e} \vert}^{2}} + \frac{1}{λ} ( \frac{{σ}_{b}^{2}}{{\vert {h}_{b} \vert}^{2}} - \frac{{σ}_{e}^{2}}{{\vert {h}_{e} \vert}^{2}} ) )} ) , & if \frac{{\vert {h}_{b} \vert}^{2}}{{σ}_{b}^{3}} > \frac{{\vert {h}_{e} \vert}^{2}}{{σ}_{e}^{2}} > 0 \\ {( \frac{{σ}_{b}^{2}}{{\vert {h}_{b} \vert}^{2}} )}^{+} = 0. & if \frac{{\vert {h}_{e} \vert}^{2}}{{σ}_{e}^{2}} \geq \frac{{\vert {h}_{b} \vert}^{2}}{{σ}_{b}^{2}} > 0\end{matrix} \\ = {p}_{ns}^{c - wf} ( h )\end{matrix} \qquad [ Equation 20 ]$$

However, λ is determined to meet the mean power condition [symbol] [pₛ^{s-wf}(h)]= P̅ₐᵥ. That is, this is given as secret water-filling pₛ^{s-wf}(h) which is described in an existing document.

As a next special case, α=0.5 will be described. In this case, the solution for the “combined water-filling” is given as below. 10

$$\begin{matrix}{p}_{ns}^{*} ( h ) = {p}_{ns}^{*} ( \vert {h}_{b} \vert ) \\ = {( \frac{0.5}{λ} - \frac{{σ}_{b}^{2}}{{\vert {h}_{b} \vert}^{2}} )}^{+} \\ = {( \frac{1}{\tilde{λ}} - \frac{{σ}_{b}^{2}}{{\vert {h}_{b} \vert}^{2}} )}^{+} \\ = {p}_{n}^{wf} ( \vert {h}_{b} \vert ) ,\end{matrix} \\ for all \vert {h}_{b} \vert and \vert {h}_{e} \vert \qquad [ Equation 21 ]$$

However, λ is acquired to meet the mean power condition [symbol] [pₐ^{wf}(|h_{b})]= P̅ₐᵥ That is, this is given as conventional water-filling pₛ^{wf}(h) which is described in an existing document. Herein, it is important that the conventional water-filling has been used for transmitting data in the existing document, but a method proposed in the present invention is used as an optimal power control method when in the conventional water-filling, both the non-secret data and the secret data are simultaneously transmitted.

In general, as a value of a increases to be close to 1, a weight for the secret data increases, and as a result, a secret channel capacity increases and a non-secret channel capacity transmitted simultaneously thereas decreases. On the contrary, as the value of a decreases to be close to 0, a weight for the non-secret data increases, and as a result, the non-secret channel capacity increases and the secret channel capacity transmitted simultaneously thereas decreases.

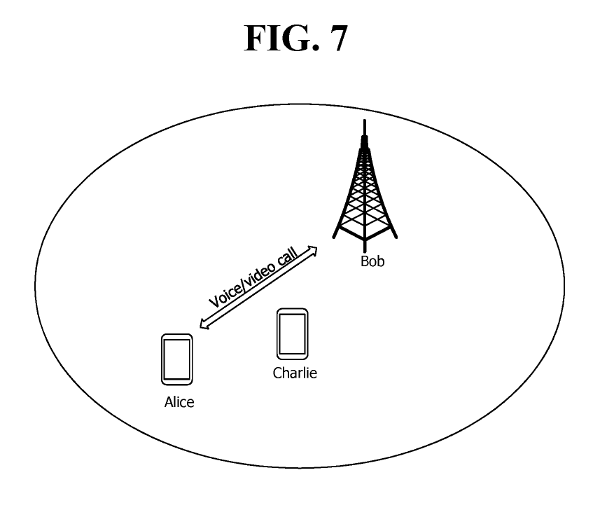

FIG. 7 shows an example in which data which is sensitive to a transmission delay is transmitted according to a second embodiment.

As seen with reference to FIG. 7, when it is considered that voice call data or image call data which is very sensitive to the transmission delay is transferred between Alice and Bob, a block length or a codeword length of the transmitted data may not sufficiently be large. Generally, in this case, a channel does not almost suffer a change within one block and a performance index under this situation is an outage channel capacity or an outage probability. The outage channel capacity may be analyzed as a meaning of a disable channel capacity and the outage probability may be analyzed as a meaning a failure probability.

Under this situation, the method for optimizing the transmission power will be described below, in each of the case in which non-secret data is transmitted, the case in which only the secret data is transmitted, or the case in which the non-secret data and the secret data are transmitted.

<A> Method for Optimizing Transmission Power in Case in which Only Non-Secret Data is Transmitted

A case in which the non-secret data which is sensitive to the transmission delay will be considered. The outage channel capacity, εₙ is given as below.

$${C}_{n}^{{ε}_{n}} := max \{ {R}_{n} : Pr ( {log}_{2} ( 1 + \frac{{\vert {h}_{b} \vert}^{2} p ( \vert {h}_{b} \vert )}{{σ}_{b}^{2}} ) < {R}_{n} ) \leq {ε}_{n} \} \qquad [ Equation 22 ]$$

Further, when target non-secret transmission rate, Rₙ is given, the outage probability is given as below.

$${P}_{n}^{out} ( {R}_{n} , p ( \vert {h}_{b} \vert ) ) := Pr ( {log}_{2} ( 1 + \frac{{\vert {h}_{b} \vert}^{2} p ( \vert {h}_{b} \vert )}{{σ}_{b}^{2}} ) < {R}_{n} ) \qquad [ Equation 23 ]$$

Two methods are considered in order to optimize power in an existing research.

A first method as a method for optimizing power minimizes the outage probability when the target non-secret transmission rate, Rₙ is given.

$${min}_{{p}_{n} ( \vert {h}_{b} \vert )} {P}_{n}^{out} ( {R}_{n} , {p}_{n} ( \vert {h}_{b} \vert ) ) \\ subject to \text{:} 𝔼 [ {p}_{n} ( \vert {h}_{b} \vert ) ] \leq {\overline{P}}_{av} . \qquad [ Equation 24 ]$$

A solution for this question is given as illustrated in Equation 24 below.

$${p}_{n}^{*} ( \vert {h}_{b} \vert ) = \{ \begin{matrix}{p}_{n}^{inv} ( \vert {h}_{b} \vert ) , & if {\vert {h}_{b} \vert}^{2} \geq \frac{{σ}_{b}^{2}}{{z}^{*}} ( {2}^{{R}_{n}} - 1 ) \\ 0 , & otherwise\end{matrix} \qquad [ Equation 25 ]$$

However, pₙ^{inv}(|h_{b}|) represents the minimum power for meet the target non-secret transmission rate, Rₙ and is given as illustrated in Equation 26 below.

$${p}_{n}^{inv} ( \vert {h}_{b} \vert ) := \frac{{σ}_{b}^{2}}{{\vert {h}_{b} \vert}^{2}} ( {2}^{{R}_{n}} - 1 ) \qquad [ Equation 26 ]$$

Herein, pₙ^{inv}(|h_{b}|) is referred to as a “channel inversion (inv)” power allocation method. Further, when a channel gain pₙ*(|h_{b}|) is equal to or more than a predetermined reference value in power is allocated through channel inversion and when the channel gain pₙ*(|h_{b}|) is equal to or less than the reference value, power is not allocated at all. The power allocation is referred to as “truncated channel inversion” power allocation.

Optimization according to a second method uses power allocation by the aforementioned truncated channel inversion as it is and optimizes the reference value itself. In this case, the target non-secret transmission rate Rₙ is not given as a constant and the value is also changed. First, the truncated channel inversion method illustrated in Equation 27 below is considered.

$${p}_{n}^{*} ( \vert {h}_{b} \vert ) = \{ \begin{matrix}\frac{β}{{\vert {h}_{b} \vert}^{2}} , & if {\vert {h}_{b} \vert}^{2} \geq {γ}_{th} \\ 0 , & otherwise .\end{matrix} \qquad [ Equation 27 ]$$

Now, a value of β that meets a mean power condition [symbol] _{γth}[p*(|h_{b}|)]=β [symbol] _{γth}[1/|h_{b}|²]= P̅ₐᵥ is given as illustrated in Equation 28 below.

$$β = \frac{{\overline{P}}_{av}}{{𝔼}_{{γ}_{th}} [ 1 / {\vert {h}_{b} \vert}^{2} ]} = \frac{{\overline{P}}_{av}}{{\int }_{{γ}_{th}}^{∞} \frac{1}{{\vert {h}_{b} \vert}^{2}} f ( {\vert {h}_{b} \vert}^{2} ) d {\vert {h}_{b} \vert}^{2}} . \qquad [ Equation 28 ]$$

The, a throughput of an actual system is given by a product of a probability at which the channel gain |h_{b}|² is more than the reference value γth and transmission rate in that case is given as illustrated in Equation 29 below.

$${\overline{C}}_{n} ( {p}_{n}^{*} ( \vert {h}_{b} \vert ) , {γ}_{th} ) = {log}_{2} ( 1 + \frac{{\overline{P}}_{av}}{{σ}_{b}^{2} {𝔼}_{{γ}_{th}} [ 1 / {\vert {h}_{b} \vert}^{2} ]} ) Pr ( {\vert {h}_{b} \vert}^{2} \geq {γ}_{th} ) \qquad [ Equation 29 ]$$

According to a third method, the optimal reference value γth is decided to maximize the system throughput.

$${\overline{C}}_{n} ( {p}_{n}^{*} ( \vert {h}_{b} \vert ) ) = {max}_{{γ}_{th}} {log}_{2} ( 1 + \frac{{\overline{P}}_{av}}{{σ}_{b}^{2} {𝔼}_{{γ}_{th}} [ 1 / {\vert {h}_{b} \vert}^{2} ]} ) Pr ( {\vert {h}_{b} \vert}^{2} \geq {γ}_{th} ) \qquad [ Equation 30 ]$$

<B> Method for Optimizing Transmission Power in Case in which Only Secret Data is Transmitted

Similarly in the case in which the non-secret data is transmitted, the outage channel capacity, εₛ is given as below in the case in which the secret data is transmitted.

$$[ Equation 31 ]$$

$${C}_{s}^{{ε}_{s}} := max \{ {R}_{s} : Pr ( {( {log}_{2} ( 1 + \frac{{\vert {h}_{b} \vert}^{2} {p}_{s} ( h )}{{σ}_{b}^{2}} ) - {log}_{2} ( 1 + \frac{{\vert {h}_{e} \vert}^{2} {p}_{s} ( h )}{{σ}_{e}^{2}} ) )}^{+} < {R}_{s} ) \leq {ε}_{s} \}$$

Further, when target secret transmission rate, Rₛ is given, the secret outage probability is given as below.

$${P}_{s}^{out} ( {R}_{s} , {p}_{s} ( h ) ) := Pr ( {( {log}_{2} ( 1 + \frac{{\vert {h}_{b} \vert}^{2} {p}_{s} ( h )}{{σ}_{b}^{2}} ) - {log}_{2} ( 1 + \frac{{\vert {h}_{e} \vert}^{2} {p}_{s} ( h )}{{σ}_{e}^{2}} ) )}^{+} < {R}_{s} ) \qquad [ Equation 32 ]$$

First, the method for optimizing power optimizes the secret outage probability when the target secret transmission rate Rₛ is given as below.

$${min}_{{p}_{s} ( h )} {P}_{s}^{out} ( {R}_{s} , {p}_{s} ( h ) ) \\ subject to \text{:} 𝔼 [ {p}_{s} ( h ) ] \leq {\overline{P}}_{av} . \qquad [ Equation 33 ]$$

A solution for this question is given as below.

$${p}_{s}^{*} ( h ) = \{ \begin{matrix}{p}_{s}^{s - inv} ( h ) , & if h ∈ {ℛ}_{s}^{s - inv} ( {z}^{*} ) \\ 0 , & otherwise\end{matrix} \qquad [ Equation 34 ]$$

However, pₛ^{s-inv}(h) and [symbol] ₛ^{s-inv} are defined as below.

$${p}_{s}^{s - inv} ( h ) := \frac{{2}^{{R}_{s}} - 1}{\frac{{\vert {h}_{b} \vert}^{2}}{{σ}_{b}^{2}} - {2}^{{R}_{s}} \frac{{\vert {h}_{e} \vert}^{2}}{{σ}_{e}^{2}}} , \\ if \\ {R}_{s} < {log}_{2} ( \frac{{\vert {h}_{b} \vert}^{2}}{{\vert {h}_{e} \vert}^{2}} \frac{{σ}_{e}^{2}}{{σ}_{b}^{2}} ) \\ or \\ \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} > 0 \\ {ℛ}_{s}^{s - inv} ( z ) := \{ h : {p}_{s}^{s - inv} ( h ) \leq z and \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} > 0 \} \qquad [ Equation 35 ]$$

Further, z*>0 is defined as below.

z*:=max{z: [symbol] [pₛ*(h)]≦ P̅ₐᵥ} [Equation 36]

In the present invention, a method for optimizing the throughput of the system is proposed in the case in which only the secret data is transmitted. To this end, the optimization of the system throughput in the case of the transmission of the non-secret data discussed in Equations 29 and 30 may be expressed by other equations. First, by

$${γ}_{th} = \frac{{σ}_{b}^{2}}{{z}^{*}} ( {2}^{{R}_{n}} - 1 ) ,$$

it may be thus mathematically illustrated that the system throughput for the non-secret data may be expressed by Equation 29 as below.

$${\overline{C}}_{n} ( {p}_{n}^{*} ( \vert {h}_{b} \vert ) , {R}_{n} ) = {R}_{n} \cdot Pr ( {\vert {h}_{b} \vert}^{2} \geq \frac{{σ}_{b}^{2}}{{z}^{*}} ( {2}^{{R}_{n}} - 1 ) ) \qquad [ Equation 37 ]$$

Next, the target non-secret transmission rate Rₙ may be optimized as below in order to maximize the system throughput.

$${\overline{C}}_{n} ( {p}_{n}^{*} ( \vert {h}_{b} \vert ) ) = {max}_{{R}_{n}} {R}_{n} \cdot Pr ( {\vert {h}_{b} \vert}^{2} \geq \frac{{σ}_{b}^{2}}{{z}^{*}} ( {2}^{{R}_{n}} - 1 ) ) \qquad [ Equation 38 ]$$

That is, optimization for the reference value γth in Equation 30 may be actually the same concept as the optimization of the target non-secret transmission rate Rₙ just as above.

Similarly as above, by considering a secret data transmitting system in the present invention, it is proposed that the target secret transmission rate Rₛ is optimized as below in order to maximize a secret transmission throughput.

$${max}_{{R}_{s}} {R}_{s} \cdot Pr ( \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} \geq \frac{{2}^{{R}_{s}} - 1}{{z}^{*}} ) \qquad [ Equation 39 ]$$

By performing the optimization, the throughput in the secret data transmitting system may be maximized. The optimization question is difficult to mathematically solve and is solved by a numerical analytical method using a computer.

<C> Method for Optimizing Transmission Power in Case in which Both Non-Secret Data and Secret Data are Transmitted

In this specification, three methods for optimizing transmission power in the case in which both the non-secret data and the secret data are transmitted are presented. Further, three methods for optimizing the target non-secret transmission rate and the target secret transmission rate are also presented.

First, the method for optimizing transmission power will be described below. First, the outage probability is defined by considering both the secret data and the non-secret data as below.

$$[ Equation 40 ]$$

$${P}_{ns}^{out} ( R , p ( h ) ) := Pr ( \begin{matrix}[ min ( {log}_{2} ( 1 + \frac{{\vert {h}_{b} \vert}^{2} {p}_{ns} ( h )}{{σ}_{b}^{2}} ) , {log}_{2} ( 1 + \frac{{\vert {h}_{e} \vert}^{2} {p}_{ns} ( h )}{{σ}_{e}^{2}} ) ) < {R}_{n} ] \\ or \\ [ {( {log}_{2} ( 1 + \frac{{\vert {h}_{b} \vert}^{2} {p}_{ns} ( h )}{{σ}_{b}^{2}} ) - {log}_{2} ( 1 + \frac{{\vert {h}_{e} \vert}^{2} {p}_{ns} ( h )}{{σ}_{e}^{2}} ) )}^{+} < {R}_{s} ]\end{matrix} )$$

In addition, an optimization question is established to minimize the outage probability.

$${min}_{{p}_{ns} ( h )} {P}_{ns}^{out} ( R , {p}_{ns} ( h ) ) \\ subject to \text{:} 𝔼 [ {p}_{ns} ( h ) ] \leq {\overline{P}}_{av} \qquad [ Equation 41 ]$$

We may mathematically acquire a solution for the question and the solution is given as below.

$${p}_{ns}^{*} ( h ) = \{ \begin{matrix}{p}_{ns}^{c - inv} ( h ) , & if h ∈ {ℛ}_{ns}^{c - inv} ( {z}^{*} ) \\ 0 , & otherwise\end{matrix} \qquad [ Equation 42 ]$$

However, a condition is given in an equation below.

$${ℛ}_{ns}^{c - inv} ( z ) := \{ h : {p}_{ns}^{c - inv} ( h ) \leq z and \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} > 0 \} \\ {z}^{*} := max \{ z : 𝔼 [ {p}_{ns}^{*} ( h ) ] \leq {\overline{P}}_{av} \} \\ {p}_{ns}^{c - inv} ( h ) = max \{ {p}_{n}^{n - inv} ( h ) , {p}_{n}^{s - inv} ( h ) \} \qquad [ Equation 43 ]$$

The aforementioned pₙ^{n-inv}(h) and pₙ^{s-inv}(h) are given as below.

$${P}_{n}^{n - inv} ( h ) = \frac{{2}^{{R}_{n}} - 1}{min \{ \frac{{\vert {h}_{b} \vert}^{2}}{{σ}_{b}^{2}} \cdot \frac{{\vert {h}_{e} \vert}^{2}}{{σ}_{e}^{2}} \}} \\ {p}_{s}^{s - inv} ( h ) := \frac{{2}^{{R}_{s}} - 1}{\frac{{\vert hs \vert}^{2}}{{σ}_{b}^{2}} - {2}^{{R}_{s}} \frac{{\vert {b}_{e} \vert}^{2}}{{σ}_{e}^{2}}} , \\ if \\ {R}_{s} < {log}_{2} ( \frac{{\vert {h}_{b} \vert}^{2}}{{\vert {h}_{e} \vert}^{2}} \frac{{σ}_{e}^{2}}{{σ}_{b}^{2}} ) \\ or \\ \frac{{\vert {h}_{b} \vert}^{2}}{{σ}_{b}^{2}} - {2}^{{R}_{e}} \frac{{\vert {h}_{e} \vert}^{2}}{{σ}_{e}^{2}} > 0. \qquad [ Equation 44 ]$$

When such a power control method is used, the system throughput C̅ₙₛ(pₙₛ*(h)) is given as below.

C̅ₙₛ(pₙₛ*(h))=Rₙ· C̅ₛ(pₙ^{n-inv}(h))·Pr(hε [symbol] ₙₛ^{c-inv}(z*) and pₙ^{n-inv}(h)≧pₛ^{s-inv}(h))+Rₛ· C̅ₙ(pₛ^{s-inv}(h))·Pr(hε [symbol] ₙₛ^{c-inv}(z*) and pₛ^{s-inv}(h)>pₙ^{n-inv}(h)) [Equation 45]

Next, a technique of optimizing the transmission power is described below. First, the outage probability for each of the secret data and the non-secret data is defined as below.

$$[ Equation 46 ]$$

$${P}_{s}^{out} ( {R}_{s} , {p}_{ns} ( h ) ) = Pr ( {( {log}_{2} ( 1 + \frac{{\vert {h}_{b} \vert}^{2} {p}_{ns} ( h )}{{σ}_{b}^{2}} ) - {log}_{2} ( 1 + \frac{{\vert {h}_{c} \vert}^{2} {p}_{ns} ( h )}{{σ}_{c}^{2}} ) )}^{+} < {R}_{s} )$$

$${P}_{n}^{out} ( {R}_{n} , {p}_{ns} ( h ) ) = Pr ( min ( {log}_{2} ( 1 + \frac{{\vert {h}_{b} \vert}^{2} {p}_{ns} ( h )}{{σ}_{b}^{2}} ) , {log}_{2} ( 1 + \frac{{\vert {h}_{c} \vert}^{2} {p}_{ns} ( h )}{{σ}_{c}^{2}} ) ) < {R}_{n} )$$

Now, a question of minimizing the outage probability for the secret data while maintaining a maximum value of the outage probability for the non-secret data may be established as below.

$$subject to \text{:} \begin{matrix}\begin{matrix}{min}_{{p}_{ns} ( h )} {P}_{s}^{out} ( {R}_{s} , {p}_{ns} ( h ) ) \\ {P}_{n}^{out} ( {R}_{n} , {p}_{ns} ( h ) ) \leq {ε}_{n}\end{matrix} \\ 𝔼 [ {p}_{ns} ( h ) ] \leq {\overline{P}}_{ac} .\end{matrix} \qquad [ Equation 47 ]$$

Accordingly, a solution for the question may be mathematically acquired and the solution is given as below.

$${p}_{ns}^{*} ( h ) = \{ \begin{matrix}{p}_{ns}^{c - inv} ( h ) , & if h ∈ {ℋ}_{n}^{n - inv} and h ∈ {ℛ}_{s}^{s - inv} ( {z}^{*} ) \\ {p}_{n}^{n - inv} ( h ) , & if h ∈ {ℋ}_{n}^{n - inv} and h ∉ {ℛ}_{s}^{s - inv} ( {z}^{*} ) \\ {p}_{s}^{s - inv} ( h ) , & if h ∉ {ℋ}_{n}^{n - inv} and h ∈ {ℛ}_{s}^{s - inv} ( {z}^{*} ) \\ 0 , & otherwise\end{matrix} \qquad [ Equation 48 ]$$

However, a condition is given in an equation below.

$${ℛ}_{s}^{s - inv} ( z ) := \{ h : {p}_{s}^{s - inv} ( h ) \leq z and \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} > 0 \} \\ {z}^{*} := max \{ z : 𝔼 [ {p}_{ns}^{*} ( h ) ] \leq {\overline{P}}_{av} \} \\ {ℋ}_{n}^{n - inv} := \{ \tilde{h} : {F}_{X ( h )} ( X ( \tilde{h} ) ) \geq {ε}_{n} \} . \qquad [ Equation 49 ]$$

In this equation, Fₓ(h)(•) represents a cumulative distribution function (CDF) of a random variable X(h) given below.

$$X ( h ) := min \{ \frac{{\vert {h}_{b} \vert}^{2}}{{σ}_{b}^{2}} \cdot \frac{{\vert {h}_{e} \vert}^{2}}{{σ}_{e}^{2}} \} \qquad [ Equation 50 ]$$

A mean power condition below should be met so that the solution given above is present.

P̅ₐᵥ≧ [symbol] [pₙ^{n-inv}(h)] [Equation 51]

When such a power control method is used, the system throughput C̅ₙₛ(pₙₛ*(h)) is given as below.

$${\overline{C}}_{ns} ( {p}_{ns}^{*} ( h ) ) = {R}_{n} \cdot {\overline{C}}_{s} ( {p}_{n}^{n - inv} ( h ) ) \cdot Pr ( h ∈ {ℋ}_{n}^{n - inv} and h ∈ {ℛ}_{s}^{s - inv} ( {z}^{*} ) and {p}_{n}^{n - inv} ( h ) \geq {p}_{s}^{s - inv} ( h ) ) + {R}_{s} \cdot {\overline{C}}_{n} ( {p}_{s}^{s - inv} ( h ) ) \cdot Pr ( h ∈ {ℋ}_{n}^{n - inv} and h ∈ {ℛ}_{s}^{s - inv} ( {z}^{*} ) and {p}_{s}^{s - inv} ( h ) > {p}_{n}^{n - inv} ( h ) ) + {R}_{n} \cdot Pr ( h ∈ {ℋ}_{n}^{n - inv} and h ∉ {ℛ}_{s}^{s - inv} ( {z}^{*} ) ) + {R}_{s} \cdot Pr ( h ∉ {ℋ}_{n}^{n - inv} and h ∈ {ℛ}_{s}^{s - inv} ( {z}^{*} ) ) . \qquad [ Equation 52 ]$$

Next, in the method for optimizing the transmission power, the outage probability for each of the secret data and the non-secret data is defined, however, the outage probability for the non-secret data is minimized while maintaining the maximum value of the outage probability for the secret data. This question is given as below.

$$subject to \text{:} \begin{matrix}\begin{matrix}{min}_{{p}_{ns} ( h )} {P}_{n}^{out} ( {R}_{n} , {p}_{ns} ( h ) ) \\ {P}_{s}^{out} ( {R}_{s} , {p}_{ns} ( h ) ) \leq {ε}_{n}\end{matrix} \\ 𝔼 [ {p}_{ns} ( h ) ] \leq {\overline{P}}_{av} .\end{matrix} \qquad [ Equation 53 ]$$

A solution for this question is given as below.

$${p}_{ns}^{*} ( h ) = \{ \begin{matrix}{p}_{ns}^{c - inv} ( h ) , & if h ∈ {ℋ}_{s}^{s - inv} and h ∈ {ℛ}_{n}^{n - inv} ( {z}^{*} ) \\ {p}_{s}^{s - inv} ( h ) , & if h ∈ {ℋ}_{s}^{s - inv} and h ∉ {ℛ}_{n}^{n - inv} ( {z}^{*} ) \\ {p}_{n}^{s - inv} ( h ) , & if h ∉ {ℋ}_{s}^{s - inv} and h ∈ {ℛ}_{n}^{n - inv} ( {z}^{*} ) \\ 0 , & otherwise\end{matrix} \qquad [ Equation 54 ]$$

However, a condition is given in an equation below.

[symbol]

ₙ^{n-inv}(z)={h:pₙ^{n-inv}(h)≦z}

z*=max{z: [symbol] [pₙₛ*(h)]≦ P̅^{av}}

[symbol]

ₛ^{s-inv}:={\tilde{h}:F_{Y}_{₍ₕ₎}(Y(\tilde{h}))≧eₛ} [Equation 55]

In this equation, F_{Y}(h)(•) represents a cumulative distribution function (CDF) of a random variable Y(h) given below.

$$Y ( h ) := \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} \qquad [ Equation 56 ]$$

Two conditions of the equation should be met so that the solution is present.

$$Pr ( \frac{{\vert {h}_{b} \vert}^{2}}{{σ}_{b}^{2}} - {2}^{{R}_{s}} \frac{{\vert {h}_{t} \vert}^{2}}{{σ}_{e}^{2}} \leq 0 ) < {ε}_{s} \\ {\overline{P}}_{av} \geq {𝔼}_{{ℋ}_{s}^{s - inv}} [ {p}_{s}^{s - inv} ( h ) ] \qquad [ Equation 57 ]$$

When such a power control method is used, the system throughput C̅ₙₛ(pₙₛ*(h)) is given as below.

$${\overline{C}}_{ns} ( {p}_{ns}^{*} ( h ) ) = {R}_{n} \cdot {\overline{C}}_{s} ( {p}_{n}^{n - inv} ( h ) ) \cdot Pr ( h ∈ {ℋ}_{s}^{s - inv} and h ∈ {ℛ}_{n}^{n - inv} ( {z}^{*} ) and {p}_{n}^{n - inv} ( h ) \geq {p}_{s}^{s - inv} ( h ) ) + {R}_{s} \cdot {\overline{C}}_{n} ( {p}_{s}^{s - inv} ( h ) ) \cdot Pr ( h ∈ {ℋ}_{s}^{s - inv} and h ∈ {ℛ}_{n}^{n - inv} ( {z}^{*} ) and {p}_{s}^{s - inv} ( h ) > {p}_{n}^{n - inv} ( h ) ) + {R}_{n} \cdot Pr ( h ∈ {ℋ}_{s}^{s - inv} and h ∉ {ℛ}_{n}^{n - inv} ( {z}^{*} ) ) + {R}_{s} \cdot Pr ( h ∉ {ℋ}_{s}^{s - inv} and h ∈ {ℛ}_{n}^{n - inv} ( {z}^{*} ) ) . \qquad [ Equation 58 ]$$

<D> Optimization of Target Secret Transmission Rate Rₛ and Target Non-Secret Transmission Rate Rₙ in Case in which Both Non-Secret Data and Secret Data are Transmitted

Three methods for optimizing the transmission power were presented above. Now, three methods for optimizing the target non-secret transmission rate Rₙ and the target secret transmission rate Rₛ are presented.

First, both Rₙ and Rₛ are optimized in order to optimize the sum in transmission rate of the non-secret data and the secret data, and the outage probability thereof. This is expressed by an equation below.

$${max}_{{R}_{n} , {R}_{s}} {\overline{C}}_{ns} ( {p}_{ns}^{*} ( h ) ) \qquad [ Equation 59 ]$$

However, herein, C̅ₙₛ(pₙₛ*(h)) is given as above.

Second, when Rₛ is given, Rₙ is optimized as below.

$${max}_{{R}_{n}} {\overline{C}}_{ns} ( {p}_{ns}^{*} ( h ) ) given {R}_{s} \qquad [ Equation 60 ]$$

However, herein, C̅ₙₛ(pₙₛ*(h)) is given as above.

Third, when Rₙ is given, Rₛ is optimized as below.

$${max}_{{R}_{s}} {\overline{C}}_{ns} ( {p}_{ns}^{*} ( h ) ) given {R}_{n} . \qquad [ Equation 61 ]$$

However, herein, C̅ₙₛ(pₙₛ*(h)) is given as above.

Three target transmission rate optimization questions are difficult to mathematically solve and are solved by a numeral analytical method using the computer.

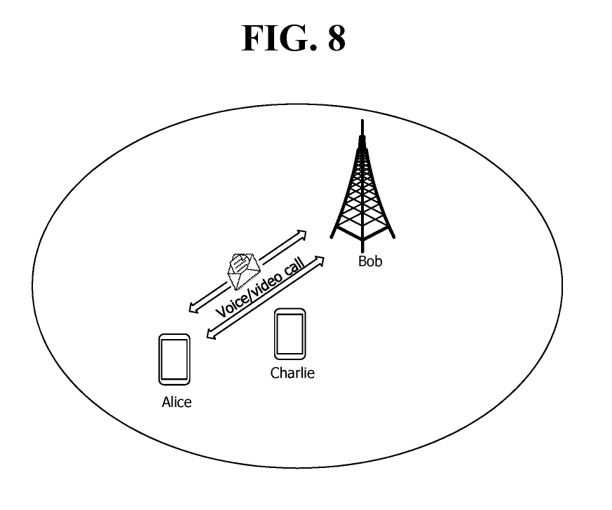

FIG. 8 shows an example in which data which is sensitive to a transmission delay is transmitted according to a third embodiment.

As seen with reference to FIG. 8, a situation in which both data such as voice call data or image call data which is very sensitive to the transmission delay and data which is not sensitive to the transmission delay are transferred between Alice and Bob is considered.

In this case, the power should be optimized by considering both the ergodic channel capacity and the outage probability discussed above.

Under this situation, the method for optimizing the transmission power will be described below, in each of the case in which non-secret data is transmitted, the case in which only the secret data is transmitted, or the case in which the non-secret data and the secret data are transmitted.

<A> Method for Optimizing Transmission Power in Case in which Only Non-Secret Data is Transmitted

Unlike FIGS. 6 and 7, when the data which is sensitive to the transmission delay and the data which is not sensitive to the transmission delay coexist, a most ideal approach method is to maximize the ergodic channel capacity while meeting the minimum outage probability condition. An optimal question below is proposed based on the idea.

$$subject to \text{:} \begin{matrix}\begin{matrix}{max}_{{p}_{n} ( \vert {h}_{b} \vert )} 𝔼 [ {log}_{2} ( 1 + \frac{{\vert {h}_{b} \vert}^{2} {p}_{n} ( \vert {h}_{b} \vert )}{{σ}_{b}^{2}} ) ] \\ Pr ( {log}_{2} ( 1 + \frac{{\vert {h}_{b} \vert}^{2} {p}_{n} ( \vert {h}_{b} \vert )}{{σ}_{b}^{2}} ) < {R}_{n} ) \leq {ε}_{n}\end{matrix} \\ 𝔼 [ {p}_{n} ( \vert {h}_{b} \vert ) ] \leq {\overline{P}}_{av} .\end{matrix} \qquad [ Equation 62 ]$$

However, herein, epsilon n represents a maximum outage probability which is permissible with respect to the non-secret data. A solution for this optimization question is given as below.

$${p}_{n}^{*} ( \vert {h}_{b} \vert ) = \{ \begin{matrix}{p}_{n}^{inv} ( \vert {h}_{b} \vert ) , & if \vert {h}_{b} \vert ∈ {ℋ}_{n}^{inv} and {\vert {h}_{b} \vert}^{2} \leq {λσ}_{b}^{2} {2}^{{R}_{n}} \\ {p}_{n}^{wf} ( \vert {h}_{b} \vert ) , & otherwise\end{matrix} \qquad [ Equation 63 ]$$

Herein, pₙ^{wf}(|h_{b}|) represents the conventional water-filling and is given by an equation below.

$${p}_{n}^{wf} ( \vert {h}_{b} \vert ) = {( \frac{1}{λ} - \frac{{σ}_{b}^{2}}{{\vert {h}_{b} \vert}^{2}} )}^{+} \qquad [ Equation 64 ]$$

However, λ is decided to meet the mean power condition P̅ₐᵥ= [symbol] [pₙ*(|h_{b}|)]. Further, [symbol] ₙ^{inv} is decided as below.

[symbol]

ₙ^{inv}={|\tilde{h}_{b}|:F_{|h}_{_{b}}_{|}_{²}(|\tilde{h}_{b}|²)≧εₙ} [Equation 65]

However, F_{|h}_{_{b}}_{|}_{²}(c)=Pr(|h_{b}|²≦c) represents a cumulative distribution function of the probability variable |h_{b}|2. A power condition below should be met so that the acquired solution is present.

P̅ₐᵥ≧ [symbol] [pₙ^{inv}(|h_{b}|)] [Equation 66]

<B> Method for Optimizing Transmission Power in Case in which Only Secret Data is Transmitted

A method is proposed, which maximizes the secret ergodic channel capacity while meeting the minimum secret outage probability condition when the data which is sensitive to the transmission delay and the secret data which is not sensitive to the transmission delay coexist. An optimization question based on such as method is given as below.

$${max}_{{p}_{s} ( h )} 𝔼 [ {( {log}_{2} ( 1 + \frac{{\vert {h}_{b} \vert}^{2} {p}_{s} ( \vert h \vert )}{{σ}_{b}^{2}} ) - {log}_{2} ( 1 + \frac{{\vert {h}_{e} \vert}^{2} {p}_{s} ( h )}{{σ}_{e}^{2}} ) )}^{+} ] \\ subject to \text{:} Pr ( {( \begin{matrix}{log}_{2} ( 1 + \frac{{\vert {h}_{b} \vert}^{2} {p}_{s} ( \vert h \vert )}{{σ}_{b}^{2}} ) - \\ {log}_{2} ( 1 + \frac{{\vert {h}_{e} \vert}^{2} {p}_{s} ( h )}{{σ}_{e}^{2}} )\end{matrix} )}^{+} < {R}_{s} ) \leq {ε}_{s} \\ 𝔼 [ {p}_{s} ( h ) ] \leq {\overline{P}}_{av} . \qquad [ Equation 67 ]$$

However, herein, εₛ represents a maximum outage probability which is permissible with respect to the secret data. We may acquire a solution for the optimization question as below.

$$\begin{matrix}[ Equation 68 ] & \\ {p}_{s}^{*} ( h ) = \{ \begin{matrix}max \{ {p}_{s}^{s - inv} ( h ) , {p}_{s}^{s - wf} ( h ) \} , & if h ∈ {ℋ}_{s}^{s - inv} \\ {p}_{s}^{s - wf} ( h ) , & if h ∉ {ℋ}_{s}^{s - inv}\end{matrix} \\ However , \\ {p}_{s}^{s - wf} ( h ) = \{ \begin{matrix}\frac{1}{2} {( - ( \frac{{σ}_{b}^{2}}{{\vert {h}_{b} \vert}^{2}} + \frac{{σ}_{e}^{2}}{{\vert {h}_{e} \vert}^{2}} ) + \sqrt{\begin{matrix}{( \frac{{σ}_{e}^{2}}{{\vert {h}_{e} \vert}^{2}} + \frac{{σ}_{b}^{2}}{{\vert {h}_{b} \vert}^{2}} )}^{2} + \\ \frac{4}{λ} ( \frac{{σ}_{e}^{2}}{{\vert {h}_{e} \vert}^{2}} - \frac{{σ}_{b}^{2}}{{\vert {h}_{b} \vert}^{2}} )\end{matrix}} )}^{+} , & if \frac{{\vert {h}_{b} \vert}^{2}}{{σ}_{b}^{2}} > \frac{{\vert {h}_{e} \vert}^{2}}{{σ}_{e}^{2}} > 0 \\ 0 , & if \frac{{\vert {h}_{e} \vert}^{2}}{{σ}_{e}^{2}} \geq \frac{{\vert {h}_{b} \vert}^{2}}{{σ}_{b}^{2}} > 0.\end{matrix} & ( 95 )\end{matrix}$$

λ>0 is acquired to meet the mean power condition [symbol] [pₛ*(h)]= P̅ₐᵥ. Two conditions below should be met so that the acquired solution is present.

$$Pr ( \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} \leq 0 ) < {ε}_{s} . \\ {\overline{P}}_{av} \geq {𝔼}_{{ℋ}_{s}^{s - inv}} [ {p}_{s}^{s - inv} ( h ) ] \qquad [ Equation 69 ]$$

<C> Method for Optimizing Transmission Power in Case in which Both Non-Secret Data and Secret Data are Transmitted

This specification presents four methods for optimizing transmission power. This case is not considered at all in the existing research.

First, in the method for optimizing the transmission power, different weights are given to a channel capacity for the non-secret data and a channel capacity for the secret data and a total channel capacity acquired by adding the values is maximized. In this case, a constraint condition is that a maximum value of the outage probability considering both the non-secret data and the secret data is constrained.

$$\begin{matrix}{max}_{{p}_{ns} ( h )} ( α {𝒞}_{s} ( {p}_{ns} ( h ) ) + ( 1 - α ) {𝒞}_{n} ( {p}_{ns} ( h ) ) ) \\ subject to \text{:} Pr ( \begin{matrix}[ min ( {log}_{2} ( 1 + \frac{{\vert {h}_{b} \vert}^{2} {p}_{ns} ( h )}{{σ}_{b}^{2}} ) , {log}_{2} ( 1 + \frac{{\vert {h}_{e} \vert}^{2} {p}_{ns} ( h )}{{σ}_{e}^{2}} ) ) < {R}_{n} ] or \\ [ {( {log}_{2} ( 1 + \frac{{\vert {h}_{b} \vert}^{2} {p}_{ns} ( h )}{{σ}_{b}^{2}} ) - {log}_{2} ( 1 + \frac{{\vert {h}_{e} \vert}^{2} {p}_{ns} ( h )}{{σ}_{e}^{2}} ) )}^{+} < {R}_{s} ]\end{matrix} ) \leq {ε}_{ns} & [ Equation 70 ] \\ 𝔼 [ {p}_{ns} ( h ) ] \leq {\overline{P}}_{av} & [ Equation 71 ]\end{matrix}$$

However, 0≦α≦1. In addition, εₙₛ represents a permissible maximum value of the outage probability considering both the secret data and the non-secret data. A solution for this optimization question is given as below.

$${p}_{ns}^{*} ( h ) = \{ \begin{matrix}max \{ {p}_{ns}^{c - inv} ( h ) , {p}_{ns}^{c - wf} ( h ) \} , & if h ∈ {ℋ}_{ns}^{c - inv} \\ {p}_{ns}^{c - wf} ( h ) , & if h ∉ {ℋ}_{ns}^{c - inv}\end{matrix} \\ However , \\ {ℋ}_{ns}^{c - inv} := \{ \tilde{h} \text{:} {F}_{Z ( h )} ( Z ( \tilde{h} ) ) \geq {ε}_{ns} \} \qquad [ Equation 72 ]$$

Herein, F_{z}(h)(•) represents a cumulative distribution function of Z(h), a probability variable defined as below.

$$\begin{matrix}Z ( h ) := min \{ \frac{min \{ \frac{{\vert {h}_{b} \vert}^{2}}{{σ}_{b}^{2}} , \frac{{\vert {h}_{e} \vert}^{2}}{{σ}_{e}^{2}} \}}{{2}^{{R}_{n}} - 1} , \frac{\frac{{\vert {h}_{b} \vert}^{2}}{{σ}_{b}^{2}} - {2}^{{R}_{s}} \frac{{\vert {h}_{e} \vert}^{2}}{{σ}_{e}^{2}}}{{2}^{{R}_{s}} - 1} \} \\ = min \{ \frac{X ( h )}{{2}^{{R}_{n}} - 1} , \frac{Y ( h )}{{2}^{{R}_{s}} - 1} \}\end{matrix} \qquad [ Equation 73 ]$$

Two conditions below should be met so that the solution is present.

$$Pr ( \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} \leq 0 ) < {ε}_{ns} , \\ {\overline{P}}_{av} \geq {𝔼}_{{ℋ}_{ns}^{c - inv}} [ {p}_{ns}^{c - inv} ( h ) ] \qquad [ Equation 74 ]$$

The second method for optimizing the transmission power is maximizing the channel capacity for the secret data. In this case, the constraint condition is to constrain the maximum value of the outage probability for the non-secret data.

$${max}_{{p}_{ns} ( h )} {𝒞}_{s} ( {p}_{ns} ( h ) ) \\ subject to \text{:} Pr ( min ( \begin{matrix}{log}_{2} ( 1 + \frac{{\vert {h}_{b} \vert}^{2} {p}_{ns} ( \vert h \vert )}{{σ}_{b}^{2}} ) , \\ {log}_{2} ( 1 + \frac{{\vert {h}_{e} \vert}^{2} {p}_{ns} ( h )}{{σ}_{e}^{2}} )\end{matrix} ) < {R}_{n} ) \leq {ε}_{n} \\ 𝔼 [ {p}_{ns} ( h ) ] \leq {\overline{P}}_{av} . \qquad [ Equation 75 ]$$

A solution for this optimization question is given as below.

$${p}_{ns}^{*} ( h ) = \{ \begin{matrix}max \{ {p}_{n}^{n - inv} ( h ) , {p}_{s}^{s - wf} ( h ) \} , & if h ∈ {ℋ}_{n}^{n - inv} \\ {p}_{s}^{s - wf} ( h ) , & if h ∉ {ℋ}_{n}^{n - inv}\end{matrix} \qquad [ Equation 76 ]$$

A mean power condition below should be met so that the solution is present.

P̅ₐᵥ≧ [symbol] [pₙ^{n-inv}(h)] [Equation 77]

The third method for optimizing the transmission power is maximizing the channel capacity for the non-secret data. In this case, the constraint condition is to constrain the maximum value of the outage probability for the secret data.

$${max}_{{p}_{ns} ( h )} {𝒞}_{n} ( {p}_{ns} ( h ) ) \\ subject to \text{:} Pr ( {( \begin{matrix}{log}_{2} ( 1 + \frac{{\vert {h}_{b} \vert}^{2} {p}_{ns} ( h )}{{σ}_{b}^{2}} ) - \\ {log}_{2} ( 1 + \frac{{\vert {h}_{e} \vert}^{2} {p}_{ns} ( h )}{{σ}_{e}^{2}} )\end{matrix} )}^{+} < {R}_{s} ) \leq {ε}_{s} \\ 𝔼 [ {p}_{ns} ( h ) ] \leq {\overline{P}}_{av} . \qquad [ Equation 78 ]$$

A solution for this optimization question is given as below.

$${p}_{ns}^{*} ( h ) = \{ \begin{matrix}max \{ {p}_{s}^{s - inv} ( h ) , {p}_{n}^{n - wf} ( h ) \} & if h ∈ {ℋ}_{s}^{s - inv} \\ {p}_{n}^{n - wf} ( h ) & if h ∉ {ℋ}_{s}^{s - inv}\end{matrix} \qquad [ Equation 79 ]$$

Two conditions below should be met so that this solution is present.

$$Pr ( \frac{{\vert {h}_{b} \vert}^{2}}{{σ}_{b}^{2}} - {2}^{{R}_{s}} \frac{{\vert {h}_{e} \vert}^{2}}{{σ}_{e}^{2}} \leq 0 ) < {ε}_{s} , \\ {\overline{P}}_{av} \geq {𝔼}_{{ℋ}_{s}^{s - inv}} [ {p}_{s}^{s - inv} ( h ) ] \qquad [ Equation 80 ]$$

A last available power optimization question is given below. First, like the to first method, different weights are given to the channel capacity for the non-secret data and the channel capacity for the secret data and a total channel capacity acquired by adding the values is maximized. In this case, the constraint condition is to make a constraint so that different maximum values are secured with respect to two outage probabilities separately considering the non-secret data and the secret data. The constraint condition is mathematically given as below.

$${max}_{{p}_{ns} ( h )} ( α {𝒞}_{s} ( {p}_{ns} ( h ) ) + ( 1 - α ) {𝒞}_{n} ( {p}_{ns} ( h ) ) ) \\ subject to \text{:} Pr ( min ( \begin{matrix}{log}_{2} ( 1 + \frac{{\vert {h}_{b} \vert}^{2} {p}_{ns} ( h )}{{σ}_{b}^{2}} ) , \\ {log}_{2} ( 1 + \frac{{\vert {h}_{e} \vert}^{2} {p}_{ns} ( h )}{{σ}_{e}^{2}} )\end{matrix} ) < {R}_{n} ) \leq {ε}_{n} \\ Pr ( {( \begin{matrix}{log}_{2} ( 1 + \frac{{\vert {h}_{b} \vert}^{2} {p}_{ns} ( h )}{{σ}_{b}^{2}} ) - \\ {log}_{2} ( 1 + \frac{{\vert {h}_{e} \vert}^{2} {p}_{ns} ( h )}{{σ}_{e}^{2}} )\end{matrix} )}^{+} < {R}_{s} ) \leq {ε}_{n} \\ 𝔼 [ {p}_{ns} ( h ) ] \leq {\overline{P}}_{av} . \qquad [ Equation 81 ]$$

However, 0≦α≦1. This question is difficult to mathematically get unlike three solved questions presented above. Therefore, a solution for the above question is acquired by a numeral analytical method using the computer.

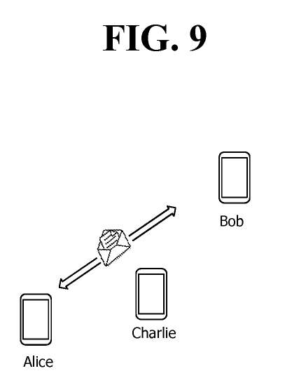

FIG. 9 shows an example of a concept of device to device (D2D) to which the embodiments can be applied.

In next-generation communication standards including 3GPP LTE-A, device to device (D2D) which is a communication between UEs is scheduled to be permitted.

That is Alice, Bob, and Charlie are shown may perform direct communication without intervention by a base station (eNodeB). Alternatively, Alice, Bob, and Charlie may directly communicate each other under the help of the base station (eNodeB).

As shown in FIG. 9 as above, the aforementioned embodiments may be applied under the situation in which Alice, Bob, and Charlie may directly communicate with each other by the D2D.

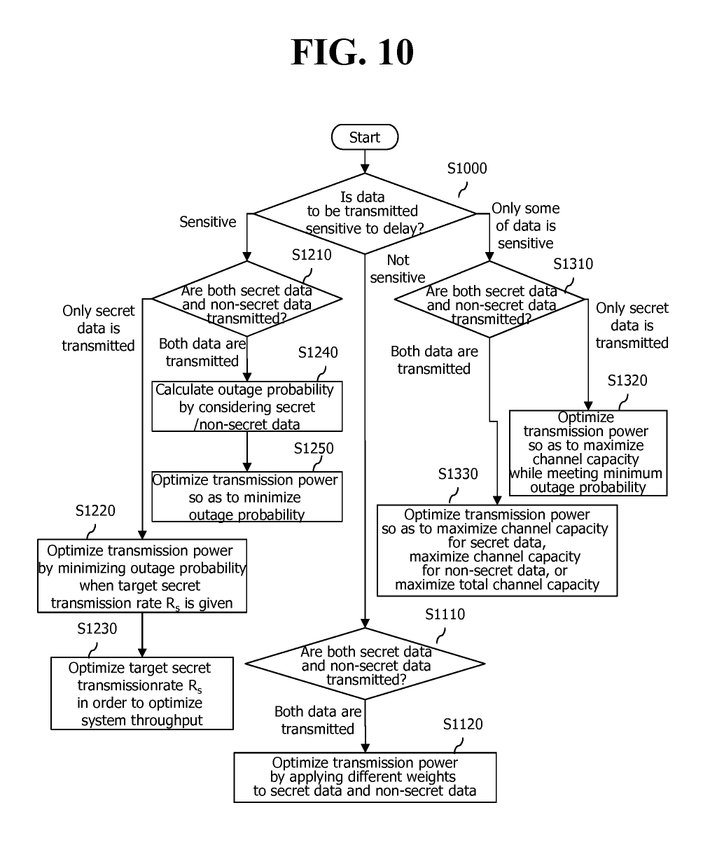

FIG. 10 is a flowchart shown by synthesizing the embodiments.

As seen with reference to FIG. 10, it is determined whether data to be transmitted by a transmitting device is sensitive to a delay (S1000).

It is determined whether both the secret data and the non-secret data are required to be transmitted when the data to be transmitted is sensitive to the delay (S1110).

As a determination result in S1110, when it is determined that both the secret data and the non-secret data are required to be transmitted, the transmitting device applies different weights to the non-secret data and the secret data and the transmission power is optimized as shown in [Equation 16] to maximize an ergodic channel capacity of the sum thereof (S1120).

In this case, the transmission power may be maximized based on [Equation 18] in order to maximize the ergodic channel capacity of the sum of the non-secret data and the secret data.

However, as described above, when α=0.5, the transmission power may be maximized by using an existing water-filling method given in [Equation 21] in order to maximize the sum of the channel capacities of the non-secret data and the secret data.

Meanwhile, in the determination step of S1000, when it is determined that the data to be transmitted is not sensitive to the delay, the transmitting device also determines whether both the secret data and the non-secret data are required to be transmitted (S1210).

According to a determination result in S1210, the optimal transmission power may be optimized by minimizing an outage probability when target secret transmission rate Rₛ is given in the case where it is determined that only the secret data is required to be transmitted (S122). Subsequently, the target secret transmission rate Rₛ may be optimized as shown in [Equation 39] in order to maximize a system throughput (S1230).

Meanwhile, according to the determination result in S1210, when it is determined that both the secret data and the non-secret data are required to be transmitted, the outage probability is calculated by considering both the non-secret data and the secret data as shown in [Equation 40] (S1240) and the transmission power may be optimized so as to minimize the outage probability as shown in [Equation 41] (S1250). In this case, [Equation 48] and [Equation 49] may be used in order to optimize the transmission power.

Alternatively, the outage probabilities for both the non-secret data and the secret data are separately configured as shown in [Equation 46] and the transmission power may be optimized so as to minimize a secret outage probability while assuring a maximum value of a non-secret outage probability as shown in [Equation 47]. In this case, [Equation 48] and [Equation 49] may be used in order to optimize the transmission power.

Further, alternatively, the outage probabilities for both the non-secret data and the secret data are separately configured as shown in [Equation 46] and the transmission power may be optimized so as to minimize the non-secret outage probability while assuring a maximum value of the secret outage probability as shown in [Equation 53]. In this case, [Equation 54] and [Equation 55] may be used in order to optimize the transmission power.

Further, alternatively, both the target secret transmission rate Rₛ and target non-secret transmission rate Rₙ may be optimized as shown in [Equation 59].

Further, alternatively, the target non-secret transmission rate Rₙ may be optimized while the target secret transmission rate Rₛ is given as shown in [Equation 60]. On the contrary, the target secret transmission rate Rₛ may be optimized while the target non-secret transmission rate Rₙ is given as shown in [Equation 61].

Meanwhile, according to the determination result in S1000, when it is determined that only some of the data to be transmitted is sensitive to the delay, the transmitting device also determines whether both the secret data and the non-secret data are required to be transmitted (S1310).

In this case, according to the determination result in S1310, when it is determined that only the secret data is transmitted, the transmission power is optimized so as to maximize the ergodic channel capacity of the secret data while meeting a minimum outage probability of the secret data as shown in [Equation 67] (S1320). In this case, [Equation 68] may be used in order to optimize the transmission power.

However, according to a determination result in S1310, when both the secret data and the non-secret data are required to be transmitted, the transmission power may be optimized so as to maximize a channel capacity for the secret data, maximize a channel capacity for the non-secret data, or maximize a total channel capacity (S1330).

For example, in order to maximize the total channel capacity, the transmission power may be optimized so as to maximize an ergodic channel capacity for the sum acquired by giving different weights to the non-secret data and the secret data and adding the weights as shown in [Equation 70], but constrain the maximum value of the outage probability by considering both the non-secret data and the secret data. In this case, [Equation 72] may be used in order to optimize the transmission power. 9

As another example, in order to maximize the total channel capacity, the transmission power may be optimized so as to maximize the ergodic channel capacity for the sum acquired by giving different weights to the non-secret data and the secret data and adding the weights, but consider the outage probability for each of the non-secret data and the secret data and constrain the maximum value of each value.

As yet another example, in order to maximize the channel capacity for the secret data, the transmission power may be optimized so as to maximize the ergodic channel capacity for the secret data as shown in [Equation 72], but constrain the maximum value of the outage probability for the non-secret data. In this case, [Equation 76] and [Equation 77] may be used in order to optimize the transmission power.

As still another example, in order to maximize the channel capacity for the non-secret data, the transmission power may be optimized so as to maximize the ergodic channel capacity for the non-secret data as shown in [Equation 78], but constrain the maximum value of the outage probability for the secret data. In this case, [Equation 79] may be used in order to optimize the transmission power.

The embodiments of the present invention described above may be implemented through a variety of means. For example, the embodiments of the present invention may be implemented by hardware, a firmware, software or a combination thereof.

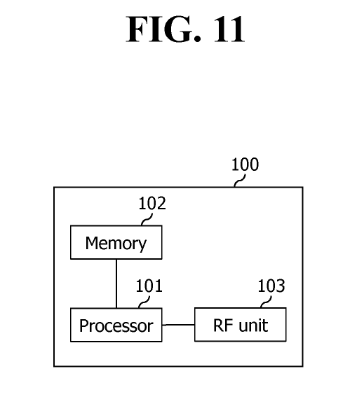

FIG. 11 is a block diagram showing a wireless communication system to implement an embodiment of the present invention.

A terminal 100 includes a processor 101, memory 102, and a radio frequency (RF) unit 103. The memory 102 is connected to the processor 101 and configured to store various information used for the operations for the processor 101. The RF unit 103 is connected to the processor 101 and configured to send and/or receive a radio signal. The processor 101 implements the proposed functions, processed, and/or methods. In the described embodiments, the operation of the terminal may be implemented by the processor 101.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for deciding transmission power in order to transmit at least one of secret data and non-secret data, the method comprising:
determining whether data to be transmitted by a transmitting device is sensitive to a delay;
determining whether both the secret data and the non-secret data are required to be simultaneously transmitted when the data to be transmitted is sensitive to the delay; and
applying different weights to the secret data and the non-secret data and deciding transmission power to maximize a total channel capacity according to the application, when it is determined that both the secret data and the non-secret data are required to be transmitted.

2. The method of claim 1, further comprising:
determining whether both the secret data and the non-secret data are required to be simultaneously transmitted when it is determined that the data to be transmitted is not sensitive to the delay;
deciding optimal transmission power by minimizing an outage probability when target secret transmission rate Rₛ is given in the case where it is determined that only the secret data is required to be transmitted; and
deciding the target secret transmission rate Rₛ in order to maximize a system throughput.

3. The method of claim 2, further comprising:
calculating the outage probability by considering both the non-secret data and the secret data when it is determined that the data to be transmitted is not sensitive to the delay and it is determined that both the secret data and the non-secret data are required to be transmitted; and
deciding transmission power to minimize the outage probability.

4. The method of claim 2, further comprising:
calculating the outage probability for each of the non-secret data and the secret data when it is determined that the data to be transmitted is not sensitive to the delay and it is determined that both the secret data and the non-secret data are required to be transmitted; and
deciding transmission power to minimize the outage probability for the secret data while assuring a maximum value of the outage probability for the non-secret data.

5. The method of claim 2, further comprising:
calculating the outage probability for each of the non-secret data and the secret data when it is determined that the data to be transmitted is not sensitive to the delay and it is determined that both the secret data and the non-secret data are required to be transmitted; and
deciding transmission power to minimize the outage probability for the non-secret data while assuring a maximum value of the outage probability for the secret data.

6. The method of claim 1, further comprising:
determining whether both the secret data and the non-secret data are required to be transmitted when it is determined that only some of the data to be transmitted is sensitive to the delay; and
deciding transmission power to maximize an ergodic channel capacity of the secret data while meeting a minimum outage probability of the secret data when it is determined that only some of the data to be transmitted is sensitive to the delay and it is determined that only the secret data is required to be transmitted.

7. The method of claim 6, further comprising:
applying different weights to the non-secret data and the secret data in order to maximize a total channel capacity for the secret data and the non-secret data when it is determined that only some of the data to be transmitted is sensitive to the delay, but both the secret data and the non-secret data are required to be transmitted; and
deciding the transmission power by considering both the outage probability for the non-secret data and the outage probability of the secret data.

8. The method of claim 6, further comprising:
applying different weights to the non-secret data and the secret data in order to maximize the total channel capacity for the secret data and the non-secret data when it is determined that only some of the data to be transmitted is sensitive to the delay, but both the secret data and the non-secret data are required to be transmitted; and
deciding the transmission power by considering both the outage probability for the non-secret data and the outage probability of the secret data.

9. The method of claim 6, further comprising:
deciding transmission power to maximize a channel capacity for the secret data, but constraint the maximum value of the outage probability for the non-secret data in order to maximize the channel capacity for the secret data when it is determined that only some of the data to be transmitted is sensitive to the delay, but both the secret data and the non-secret data are required to be transmitted.

10. The method of claim 6, further comprising:
deciding transmission power to maximize a channel capacity for the non-secret data, but constraint the maximum value of the outage probability for the secret data in order to maximize the channel capacity for the non-secret data when it is determined that only some of the data to be transmitted is sensitive to the delay, but both the secret data and the non-secret data are required to be transmitted.
